(19) United States
(12) Patent Application Publication
(10) Pub. No.: US 2021/0249868 A1
(43) Pub. Date: Aug. 12, 2021

(54) BATTERY CONNECTION DEVICE HEALTH STATUS DETECTION SYSTEM AND METHOD, AND UNMANNED AERIAL VEHICLE

(71) Applicant: SZ DJI TECHNOLOGY CO., LTD., Shenzhen (CN)

(72) Inventor: Qiu LAN, Shenzhen (CN)

(21) Appl. No.: 17/242,269

(22) Filed: Apr. 27, 2021

Related U.S. Application Data
(63) Continuation of application No. PCT/CN2018/112729, filed on Oct. 30, 2018.

(51) Int. Cl. H02J 7/00; B60L 3/00

(52) U.S. Cl. CPC H02J 7/005; B60L 3/0046; H02J 7/0063

(57) ABSTRACT

A detection system includes a control circuit, a control system, and a detection circuit. The control circuit is configured to control on-off of a battery cell. An input end of the control circuit is configured to be connected to the battery cell, and an output end of the control circuit is configured to be connected to a battery connection device. The control system is configured to be connected to the battery connection device and to control the battery cell to supply power to the control system via the battery connection device. The detection circuit is connected to the control circuit or the control system and is configured to detect a parameter value of the battery connection device. The control circuit or the control system is further configured to determine health status of the battery connection device according to the parameter value of the battery connection device.

### CROSS-REFERENCE TO RELATED APPLICATION

This application is a continuation of International Application No. PCT/CN2018/112729, filed Oct. 30, 2018, the entire content of which is incorporated herein by reference.

### TECHNICAL FIELD

The present disclosure relates to the technical field of unmanned aerial vehicle and, more particularly, to a battery connection device health status detection system and method, and an unmanned aerial vehicle.

### BACKGROUND

An unmanned aerial vehicle battery is connected to an unmanned aerial vehicle body through a battery connection device to provide electricity for the unmanned aerial vehicle body. As use time increases, the battery connection device may degrade in function due to various factors, leading to an increased risk of failure. However, existing unmanned aerial vehicles lack a detection of health status of the battery connection device, and it is impossible to know whether the battery connection device is on the verge of failure. If an unmanned aerial vehicle continues to fly with the battery connection device that is on the verge of failure, it will easily cause a power interruption and initiate a flight accident.

### SUMMARY

In accordance with the disclosure, there is provided a detection system including a control circuit, a control system, and a detection circuit. The control circuit is configured to control on-off of a battery cell. An input end of the control circuit is configured to be connected to a battery cell, and an output end of the control circuit is configured to be connected to a battery connection device. The control system is configured to be connected to the battery connection device and to control the battery cell to supply power to the control system via the battery connection device. The detection circuit is connected to the control circuit or the control system and is configured to detect a parameter value of the battery connection device. The control circuit or the control system is further configured to determine health status of the battery connection device according to the parameter value of the battery connection device.

Also in accordance with the disclosure, there is provided an unmanned aerial vehicle including a battery, a vehicle body, and a battery connection device. The battery includes a battery cell and a control circuit configured to control on-off of the battery cell. An input end of the control circuit is connected to the battery cell, and an output end of the control circuit is connected to the battery connection device. The vehicle body includes a control system connected to the battery connection device. The control system is configured to control the battery cell to supply power to the control system via the battery connection device. The battery further includes a detection circuit connected to the control circuit or the vehicle body further includes the detection circuit connected to the control system. The detection circuit is configured to detect a parameter value of the battery connection device. The control circuit or the control system is further configured to determine health status of the battery connection device according to the parameter value of the battery connection device.

Also in accordance with the disclosure, there is provided a detection method including detecting a parameter value of a battery connection device and determining health status of the battery connection device according to the parameter value of the battery connection device.

### BRIEF DESCRIPTION OF THE DRAWINGS

The accompanying drawings are included to provide further understanding of the present disclosure and constitute a part of the disclosure. Together with the following description of the embodiments, the drawings are used to explain the present disclosure, but do not constitute a limitation to the present disclosure.

FIG. 1 is a schematic structural diagram of a battery connection device health status detection system according to an embodiment of the present disclosure.

FIG. 2 is a circuit connection diagram of the detection system shown in FIG. 1.

FIG. 3 is a schematic structural diagram of a battery connection device health status detection system according to another embodiment of the present disclosure.

FIG. 4 is a circuit connection diagram of the detection system shown in FIG. 3.

FIG. 5 is a schematic structural diagram of an unmanned aerial vehicle according to an embodiment of the present disclosure.

FIG. 6 is another schematic structural diagram of an unmanned aerial vehicle according to an embodiment of the present disclosure.

FIG. 7 is a flow chart of a battery connection device health status detection method according to an embodiment of the present disclosure.

Reference numerals: battery connection device health status detection system 1a, 1b; control circuit 10; control system 20; detection circuit 30; battery connection device 40; power supply side positive connector 41; power receiving side positive connector 41′; power supply side negative connector 42; power receiving side negative connector 42′; battery 50; battery management system 51; vehicle body 60; battery cell Bat; power supply pin P; detection pin D; data line Data; voltage of the power supply side positive connector VBat+; voltage of the power supply side negative connector VBat−; voltage of the power receiving side positive connector VPwr+; voltage of the power receiving side negative connector VPwr−; current flowing through the power supply side positive connector and the power receiving side positive connector IBat+; current flowing through the power supply side negative connector and the power receiving side negative connector IBat−; power line Bat+, Bat−, Pwr+, Pwr−.

### DETAILED DESCRIPTION OF THE EMBODIMENTS

The technical solutions in the embodiments of the present disclosure will be described in detail with reference to the accompanying drawings. Obviously, the described embodiments are only some of rather than all the embodiments of the present disclosure. Based on the described embodiments, all other embodiments obtained by those of ordinary skill in the art without inventive effort shall fall within the scope of the present disclosure.

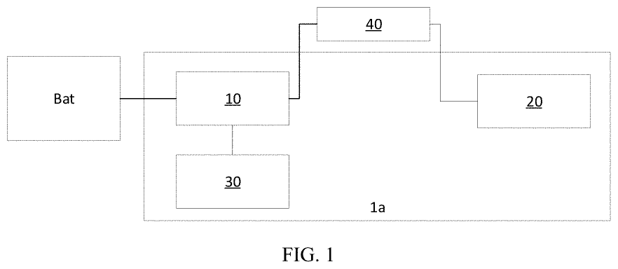

An embodiment of the present disclosure provides a battery connection device health status detection system. As shown in FIG. 1, the detection system 1a includes a control circuit 10, a control system 20, and a detection circuit 30. The input end of the control circuit 10 is configured to connect a battery cell Bat, and the output end is connected to a battery connection device 40. The control circuit 10 is configured to control the on-off of the battery cell Bat. The control system 20 is connected to the battery connection device 40. Under the control of the control circuit 10, the battery cell Bat can supply power to the control system 20 through the battery connection device 40. The detection circuit 30 is connected to the control circuit 10 for detecting parameter values of the battery connection device 40. The control circuit 10 is configured to determine health status of the battery connection device 40 in real time according to the parameter values.

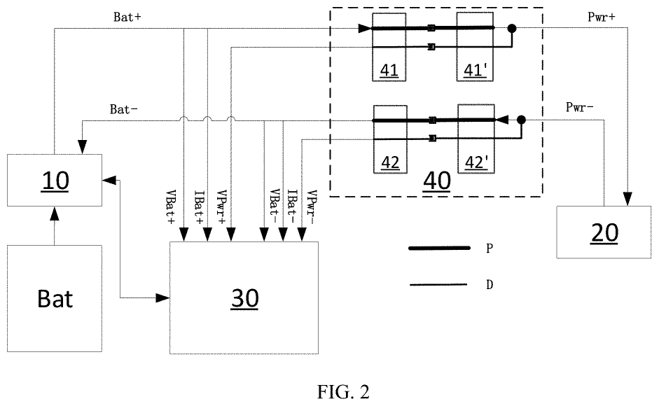

The control circuit 10 and the control system 20 are electrically coupled through the battery connection device 40. As shown in FIG. 2, the battery connection device 40 includes two pairs of connectors: a power supply side positive connector 41 and a power receiving side positive connector 41′ that are plugged together, and a power supply side negative connector 42 and a power receiving side negative connector 42′ that are plugged together. The power supply side positive connector 41 is connected to a power supply pin P of the power receiving side positive connector 41′, and the power supply side negative connector 42 is connected to the power supply pin P of the power receiving side negative connector 42′. The power supply side positive connector 41 is connected to the positive terminal of the control circuit 10 via a power line Bat+, and the power receiving side positive connector 41′ is connected to the positive terminal of the control system 20 via a power line Pwr+. The power supply side negative connector 42 is connected to the negative terminal of the control circuit 10 via a power line Bat−, and the power receiving side negative connector 42′ is connected to the negative terminal of the control system 20 via a power line Pwr−. The detection circuit 30 is connected to the power supply side positive connector 41 and the power supply side negative connector 42 through two sets of wires for detecting the parameter values of the battery connection device 40.

After the control circuit 10 is connected to the battery cell Bat, under the control of the control circuit 10, the battery cell Bat supplies power to the control system 20 via the power supply side positive connector 41 and the power receiving side positive connector 41′, as well as the power supply side negative connector 42 and the power receiving side negative connector 42′.

In some embodiments, the parameter values of the battery connection device 40 include: voltage values of the power supply side connectors, voltage values of the power receiving side connectors, and current values flowing through the power supply side connectors and the power receiving side connectors. The detection circuit 30 respectively collects the voltage of the power supply side positive connector 41 VBat+and the current flowing through the power supply side positive connector 41 and the power receiving side positive connector 41′ IBat+ through one set of wires, and respectively collects the voltage of the power supply side negative connector 42 VBat− and the current flowing through the power supply side negative connector 42 and the power receiving side negative connector 42′ IBat− through the other set of wires. The detection circuit 30 detects the collected voltage and current described above, and obtains the voltage values of the power supply side positive connector 41 and the power supply side negative connector 42, the current value flowing through the power supply side positive connector 41 and the power receiving side positive connector 41′, and the current value flowing through the power supply side negative connector 42 and the power receiving side negative connector 42′.

In addition to the power supply pins P, both the power supply side connectors and the power receiving side connectors also have detection pins D. The detection circuit 30 detects the voltage value of the power receiving side connectors through the detection pins D. Specifically, after the power supply side connectors and the power receiving side connectors are plugged together, the power supply side positive connector 41 is connected to the detection pin D of the power receiving side positive connector 41′, and the power supply side negative connector 42 is connected to the detection pin D of the power receiving side negative connector 42′, where the two detection pins D are both connected to the detection circuit 30 via wires. The detection circuit 30 collects the voltage VPwr+ of the power receiving side positive connector 41′ and the voltage VPwr− of the power receiving side negative connector 42′ through the detection pins D. The detection circuit 30 detects the collected voltage described above, and obtains the voltage values of the power receiving side positive connector 41′ and the power receiving side negative connector 42′.

The control circuit 10 receives the parameter values described above detected by the detection circuit 30, and obtains impedance values of the power supply side connectors and the power receiving side connectors according to these parameter values, so as to determine the health status of the battery connection device 40 in real time. Such an impedance value is also referred to as “connector impedance value.”

Specifically, for the power supply side positive connector 41 and the power receiving side positive connector 41′, the control circuit 10 calculates the difference between the voltage value at the power supply side positive connector 41 and the voltage value at the power receiving side positive connector 41′, and then divides the difference by the current value flowing through the power supply side positive connector 41 and the power receiving side positive connector 41′ to obtain the impedance value of the power supply side positive connector 41 and the power receiving side positive connector 41′. Such an impedance value is also referred to as a “positive connector impedance value”. Similarly, for the power supply side negative connector 42 and the power receiving side negative connector 42′, the control circuit 10 calculates the difference between the voltage value at the power supply side negative connector 42 and the voltage value at the power receiving side negative connector 42′, and then divides the difference by the current value flowing through the power supply side negative connector 42 and the power receiving side negative connector 42′ to obtain the impedance value of the power supply side negative connector 42 and the power receiving side negative connector 42′. Such an impedance value is also referred to as a “negative connector impedance value.” Based on the embodiments of the present disclosure, the impedance value of the power supply side positive connector 41 and the power receiving side positive connector 41′, and the impedance value of the power supply side negative connector 42 and the power receiving side negative connector 42′ can be obtained separately. Then, the positive and negative connectors can be individually monitored, and fault locations can be accurately located.

A connector of the battery connection device 40 will degrade in function due to factors such as vibration, aging, oxidation, chemical corrosion, etc., causing the impedance of the connector to increase. Therefore, if the impedance value of the connector reaches a certain level, it means that the connector may fail due to functional degradation, and may even cause local burnout due to thermal effect of the current, thereby affecting the reliability and safety of battery power supply. Therefore, the control system 20 of some embodiments determines whether the impedance value exceeds a threshold value. If the impedance value does not exceed the threshold value, it indicates that the connector is good in health status and there is no risk of failure. If the threshold is exceeded, the health status of the connector is determined to be poor, indicating that the risk of connector failure is high and the connector should not be used any longer.

Specifically, the threshold value may be determined according to an attribute (e.g., type) of the connector. If the impedance value of the power supply side positive connector 41 and the power receiving side positive connector 41′ is greater than the threshold value, it indicates a poor health status of this positive connector pair. If the impedance value of the power supply side negative connector 42 and the power receiving side negative connector 42′ is greater than the threshold value, it indicates a poor health status of this negative connector pair. The detection system 1a can perform determination for the positive connectors or the negative connectors, and infer an overall status of the battery connection device 40. The detection system 1a can also perform determination for both the positive connectors and the negative connectors to comprehensively and accurately detect the health status of the battery connection device 40.

In the detection process, there may be factors such as vibration that cause an anomaly in the detection value, thereby affecting the accuracy of the connector detection. In order to improve the detection accuracy, the detection circuit 30 of some embodiments detects multiple sets of parameter values described above. The control circuit 10 uses the multiple sets of parameter values as multiple sets of impedance sampling values, and filters the multiple sets of impedance sampling values to obtain accurate impedance value of the power supply side positive connector 41 and the power receiving side positive connector 41′, and the accurate impedance value of the power supply side negative connector 42 and the power receiving side negative connector 42′. The filtering in some embodiments may be time-domain filtering such as median filtering, which can filter out and exclude abnormal impedance sampling values, thereby obtaining stable and accurate impedance values.

The median filtering method will be explained via an example. The control circuit 10 samples and calculates N groups of impedance sampling values within a time period, where the N groups of impedance sampling values include the impedance values of the power supply side positive connector 41 and the power receiving side positive connector 41′, and the impedance values of the power supply side negative connector 42 and the power receiving side negative connector 42′. In the median filtering process, for the power supply side positive connector 41 and the power receiving side positive connector 41′, M1 groups of samples with the largest impedance sampling values and M1 groups of samples with the smallest impedance sampling values are discarded; for the power supply side negative connector 42 and the power receiving side negative connector 42′, M2 groups of samples with the largest impedance sampling values and M2 groups of samples with the smallest impedance sampling values are discarded; and the remaining impedance sampling values are the sampling values after the median filtering. The advantage of the median filtering is that it can eliminate anomalies in the collected values due to abnormal disturbances, which is conducive to long-term impedance monitoring.

A current flowing through the connector will cause the connector to heat up. If the impedance value is too high, temperature of the connector will increase. As such, the health status of the connector can also be determined by determining the temperature of the connector. The control circuit 10 can also obtain the temperature value of the connector from the impedance value. For example, the control circuit 10 can obtain the temperature value of the power supply side positive connector 41 and the power receiving side positive connector 41′ (“positive connector temperature”) based on the impedance value of the power supply side positive connector 41 and the power receiving side positive connector 41′, and the current flowing through the power supply side positive connector 41 and the power receiving side positive connector 41′. The control circuit 10 can also obtain the temperature value of the power supply side negative connector 42 and the power receiving side negative connector 42′ (“negative connector temperature”) based on the impedance value of the power supply side negative connector 42 and the power receiving side negative connector 42′, and the current flowing through the power supply side negative connector 42 and the power receiving side negative connector 42′. The control circuit 10 determines whether the temperature value exceeds a threshold value, and if so, it is determined that the health status of the positive connectors and/or the negative connectors is poor.

When the control circuit 10 determines that the battery connection device 40 is in poor health status, the control circuit 10 can generate a prompt message and send the message to the control system 20 to notify the control system 20 that the battery connection device 40 is no longer suitable for use.

Further, the control circuit 10 of some embodiments can also predict the life of the battery connection device 40 according to multiple impedance values. These multiple impedance values are the impedance values obtained at multiple moments in the past. According to these impedance values, a rule of the impedance value changing with time can be found, so as to infer the time when the impedance value reaches the threshold value, thereby determining the health status of the battery connection device 40 at future moments.

It can be seen that the detection system 1a provided in some embodiments determines the health status of the battery connection device 40 through the impedance values of the connectors, and gives corresponding prompts, thereby improving the reliability and safety of the battery power supply. Further, no additional connectors are needed, but only detection pins are added in the connectors to detect the voltage values of the power receiving side connectors. As such, circuit area and cost will not increase significantly.

The description above is only exemplary, and the present disclosure is not limited thereto. The battery connection device 40 includes one pair or more than two pairs of connectors, and detection manner for each pair of connectors is the same as that for the two pairs of connectors described above. When the battery connection device 40 includes two or more pairs of connectors, the health status of some or all of the connectors can be detected.

Another embodiment of the present disclosure provides a battery connection device health status detection system. For a brief description of the detection system, the same or similar content as the previous embodiment will not be repeated, and only the content that is different from the previous embodiment will be described below.

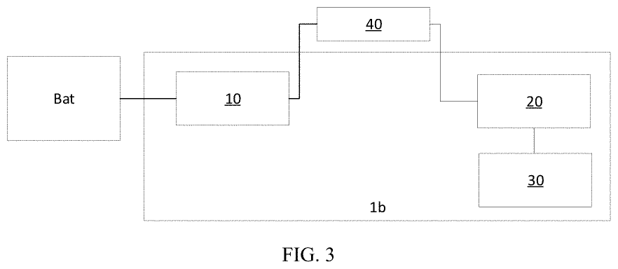

FIG. 3 shows a detection system 1b according to another embodiment of the disclosure. The detection system 1b differs from the detection system 1a in that the detection circuit 30 is connected to the control system 20 for detecting the parameter values of the battery connection device 40. The function of the control circuit 10 in the previous embodiment is instead performed by the control system 20 which is configured to determine the health status of the battery connection device 40 in real time according to the parameter values.

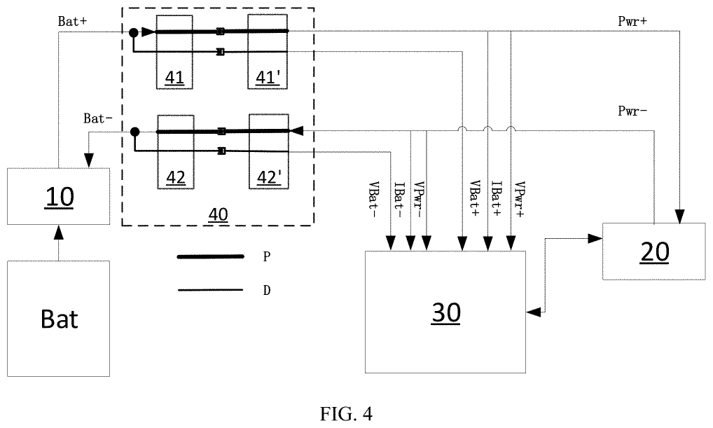

As shown in FIG. 4, the detection circuit 30 collects the voltage of the power receiving side positive connector 41′ VPwr+ and the current flowing through the power supply side positive connector 41 and the power receiving side positive connector 41′ IBat+ through one set of wires, and collects the voltage of the power receiving side negative connector 42′ VPwr− and the current flowing through the power supply side negative connector 42 and the power receiving side negative connector 42′ IBat− through another set of wires. The detection circuit 30 detects the collected voltage and current described above, and obtains the voltage values of the power receiving side positive connector 41′ and the power receiving side negative connector 42′, the current value flowing through the power supply side positive connector 41 and the power receiving side positive connector 41′, and the current value flowing through the power supply side negative connector 42 and the power receiving side negative connector 42′.

In addition to the power supply pins P, both the power supply side connectors and the power receiving side connectors also have detection pins D. The detection circuit 30 detects the voltage value of the power supply side connectors through the detection pins D. Specifically, after the power supply side connectors and the power receiving side connectors are plugged together, the power supply side positive connector 41 is connected to the detection pin D of the power receiving side positive connector 41′, and the power supply side negative connector 42 is connected to the detection pin D of the power receiving side negative connector 42′, where the two detection pins D are both connected to the detection circuit 30 via wires. The detection circuit 30 collects the voltage VBat+ of the power supply side positive connector 41 and the voltage VBat− of the power supply side negative connector 42 through the detection pins D. The detection circuit 30 detects the collected voltage described above, and obtains the voltage values of the power supply side positive connector 41 and the power supply side negative connector 42.

The control system 20 receives the parameter values described above detected by the detection circuit 30, and obtains impedance values of the power supply side connectors and the power receiving side connectors according to these parameter values, so as to determine the health status of the battery connection device 40 in real time.

The control system 20 determines whether the impedance value exceeds the threshold value. If the impedance value does not exceed the threshold value, it indicates that the connector is good in health status and there is no risk of failure. If the threshold is exceeded, the health status of the connector is determined to be poor, indicating that the risk of connector failure is high and it cannot be used any longer.

The detection circuit 30 of some embodiments detects multiple sets of parameter values described above. The control system 20 uses the multiple sets of parameter values as multiple sets of impedance sampling values, and filters the multiple sets of impedance sampling values to obtain accurate impedance value of the power supply side positive connector 41 and the power receiving side positive connector 41′, and the accurate impedance value of the power supply side negative connector 42 and the power receiving side negative connector 42′.

The control system 20 can also obtain the temperature value of the connector from the impedance value. The control system 20 determines whether the temperature value exceeds the threshold value, and if so, it is determined that the health status of the positive connectors and/or the negative connectors is poor.

When the control system 20 determines that the battery connection device 40 is in poor health status, the control system 20 can generate a prompt message and send the message to the control circuit 10 to notify the control circuit 10 that the battery connection device 40 is no longer suitable for use.

The control system 20 can also predict the life of the battery connection device 40 according to multiple impedance values. These multiple impedance values are the impedance values obtained at multiple moments in the past (“past moments”). According to these impedance values, a rule of the impedance value changing with time can be found, so as to infer the time when the impedance value reaches the threshold value, thereby determining the health status of the battery connection device 40 at future moments.

It can be seen that the detection system 1b provided in some embodiments determines the health status of the battery connection device 40 through the impedance values of the connectors, and gives corresponding prompts, thereby improving the reliability and safety of the battery power supply. Further, no additional connectors are needed, but only detection pins are added in the connectors to detect the voltage values of the power receiving side connectors. As such, circuit area and cost will not increase significantly.

The present disclosure also provides an unmanned aerial vehicle, which includes a battery, a vehicle body, a battery connection device, and a battery connection device health status detection system consistent with the disclosure such as one of the example detection systems described above.

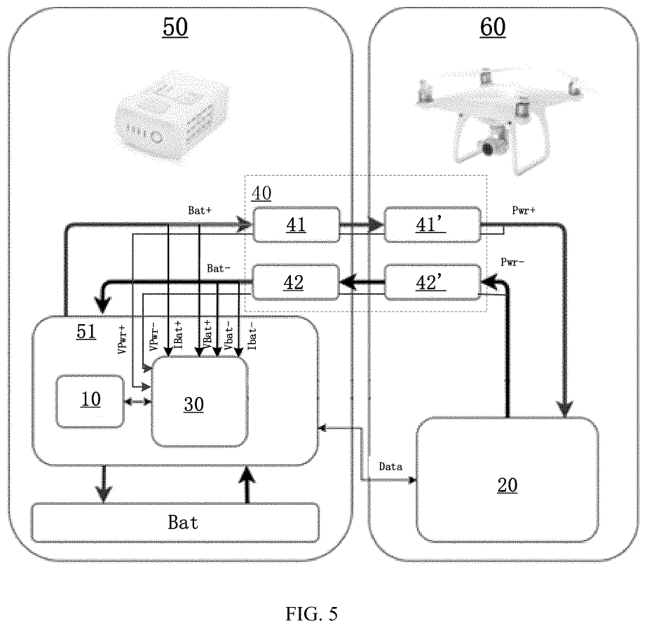

As shown in FIG. 5, the unmanned aerial vehicle employs the detection system 1a. A battery 50 is used to supply power to a vehicle body 60 of the unmanned aerial vehicle, and includes a battery cell Bat and a battery management system 51. The control circuit 10 and the detection circuit 30 of the detection system are integrated in the battery management system 51.

The vehicle body 60 includes the control system 20 of the detection system and a propulsion system. The battery cell Bat supplies power to the control system 20 and the propulsion system, and the control system 20 controls flight of the unmanned aerial vehicle by controlling actions of the propulsion system. The control system 20 of the vehicle body 60 and the control circuit 10 of the battery management system 51 can also communicate via a data line Data, and the control system 20 can obtain information such as battery signals, operating status through the data line Data.

In FIG. 5, the battery connection device 40 includes two pairs of connectors: a power supply side positive connector 41 and a power receiving side positive connector 41′ that are plugged together, and a power supply side negative connector 42 and a power receiving side negative connector 42′ that are plugged together. The power supply side positive connector 41 and the power supply side negative connector 42 are connectors of the battery 50, while the power receiving side positive connector 41′ and the power receiving side negative connector 42′ are connectors of the vehicle body 60.

The detection circuit 30 detects the voltage value of the power supply side positive connector 41, the voltage value of the power receiving side positive connector 41′, the voltage value of the power supply side negative connector 42, the voltage value of the power receiving side negative connector 42′, the current value flowing through the power supply side positive connector 41 and the power receiving side positive connector 41′, and the current value flowing through the power supply side negative connector 42 and the power receiving side negative connector 42′. The control circuit 10 calculates the impedance value of the power supply side positive connector 41 and the power receiving side positive connector 41′, and the impedance value of the power supply side negative connector 42 and the power receiving side negative connector 42′. The control circuit 10 accordingly determines the health status of the battery connection device 40. The detection systems in the embodiments described above can be referred to for the specific detection and determination methods.

When the control circuit 10 determines that the battery connection device 40 is in poor health status, the control circuit 10 can generate a flight prohibition prompt message and send the message to the control system 20 of the vehicle body 60 to notify the control system 20 that the battery connection device 40 is no longer suitable for use. In this way, when the unmanned aerial vehicle receives the flight prohibition prompt message during flight, the unmanned aerial vehicle can return in time, which avoids flight accident caused by the failure of the battery connection device and improvs the flight reliability and safety of the unmanned aerial vehicle. When the unmanned aerial vehicle receives the flight prohibition prompt message before takeoff, the flight can be stopped in time, or be performed after the battery connection device is replaced, which can prevent the flight accident caused by the failure of the battery connection device before taking off and improve the flight reliability and safety of the unmanned aerial vehicle. By predicting the life of the battery connection device, users can be reminded to replace and maintain the battery connection device in time, which further improves the maintenance convenience and safety of the unmanned aerial vehicle.

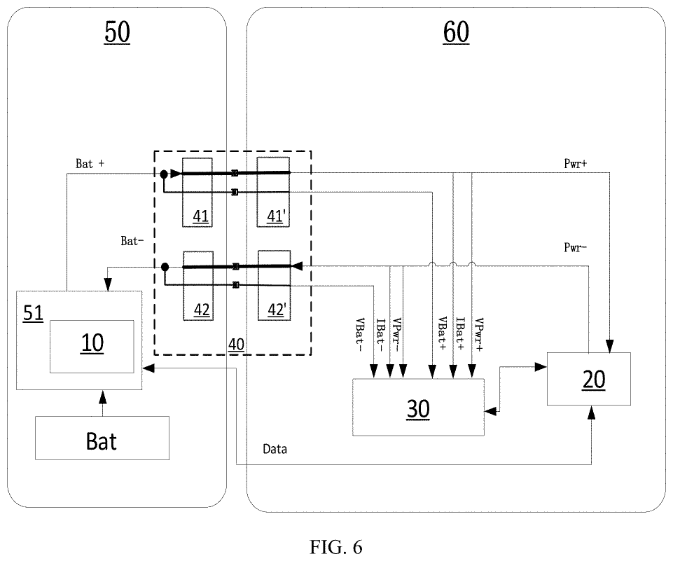

The unmanned aerial vehicle using the detection system 1a shown in FIG. 1 and FIG. 2 is described above with reference to FIG. 5. Of course, the unmanned aerial vehicle of the present disclosure can also employ the detection system 1b shown in FIG. 3 and FIG. 4. As shown in FIG. 6, the detection circuit 30 is not integrated in the battery management system 51 of the battery 50, but provided in the vehicle body 60, which is especially applicable for a situation where the internal space of the battery is limited. For the unmanned aerial vehicle with the detection circuit 30 arranged on the vehicle body 60, the working process is similar to that of the unmanned aerial vehicle of FIG. 5 described above, and the technical effects described above can also be achieved.

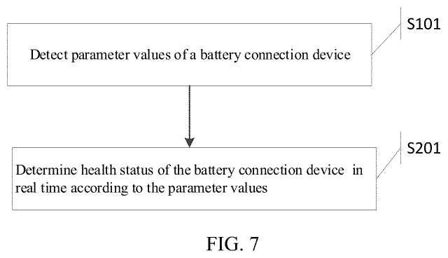

The present disclosure also provides a battery connection device health status detection method. The detection method uses a detection system described above to detect health status of a battery connection device. Referring to FIG. 7, the detection method includes: detecting parameter values of the battery connection device (S101); and determining the health status of the battery connection device in real time according to the parameter values (S201). The battery connection device includes at least one pair of connectors, and each pair of connectors includes a power supply side connector and a power receiving side connector.

When the battery connection device includes multiple pairs of connectors, in S101, the parameter values of at least one of the multiple pairs of connectors are detected; in S201, the health status of at least one of the multiple pairs of connectors is determined according to the parameter values. The multiple pairs of connectors may be two pairs of connectors: a power supply side positive connector and a power receiving side positive connector, a power supply side negative connector and a power receiving side negative connector.

The parameter values of the battery connection device in the present disclosure can include: the voltage value of the power supply side connector, the voltage value of the power receiving side connector, and the current value flowing through the power supply side connector and the power receiving side connector.

In some embodiments, S201 specifically includes obtaining impedance values of the power supply side connector and the power receiving side connector according to the parameter values described above, so as to determine the health status of the battery connection device in real time.

In some embodiments, in S201, determining the health status of the battery connection device in real time includes determining whether the impedance value exceeds a threshold value, and if so, determining that the health status of the power supply side connector and the power receiving side connector is poor. In this case, a flight prohibition prompt message is issued. In some other embodiments, determining the health status of the battery connection device in real time includes obtaining the temperature value of the power supply side connector and the power receiving side connector according to the impedance value, determining whether the temperature value exceeds a threshold value, and if so, determining that the health status of the power supply side connector and the power receiving side connector is poor. In this case, the flight prohibition prompt message is issued.

In some embodiments, in S201, obtaining the impedance values of the power supply side connector and the power receiving side connector according to the parameter values described above includes obtaining multiple impedance sampling values according to multiple sets of parameter values, and filtering the multiple impedance sampling values to obtain the impedance values of the power supply side connector and the power receiving side connector.

The detection method may further include determining the health status of the battery connection device at future moments based on the impedance values at multiple moments in the past.

It can be seen that, in the present disclosure, the health status of the battery connection device is determined by the impedance values of the connectors, and corresponding prompts are given, thereby improving the reliability and safety of battery power supply.

In an example embodiment, the fault type of the connector can be determined based on the long-term collection and monitoring of the resistance value. For example, if the change in resistance value is caused by oxidation of the connector, since oxidation affects external surface area of the resistance connector, and then the influence of oxidation gradually becomes smaller, the rule of resistance change caused by this type of change is that the resistance gradually increases, and the increase rate starts faster and then gradually slows down. As another example, if the change in resistance value is caused by vibration, the contact area between the connectors will change with the vibration, and the measured resistance value will also appear in a form of reciprocal changes. Chemical corrosion will present a sudden change in resistance. The contact problem caused by aging of the connector device will result in the impedance fluctuating from high to low during many different uses.

Those skilled in the art can clearly understand that for the convenience and conciseness of the description, only the division of the functional modules described above is used as an example for illustration. In practical applications, the functions described above can be allocated by different functional modules as required, i.e., the internal structure of the device is divided into different functional modules to complete all or some of the functions described above. For specific working process of the device described above, reference may be made to the corresponding process in the embodiments described above, which will not be repeated herein.

Finally, it should be noted that the embodiments described above are only used to illustrate the technical solutions of the present disclosure rather than limiting them. Although the present disclosure has been described in detail with reference to all the described embodiments, those of ordinary skill in the art should understand that the technical solutions in all the described embodiments can still be modified, or some or all of the technical features can be equivalently replaced. The modifications or replacements do not cause the essence of the corresponding technical solutions to depart from the scope of the technical solutions in the embodiments of the present disclosure.

What is claimed is:

1. A detection system comprising:
a control circuit configured to control on-off of a battery cell, an input end of the control circuit being configured to be connected to the battery cell, and an output end of the control circuit being configured to be connected to a battery connection device;
a control system configured to be connected to the battery connection device and to control the battery cell to supply power to the control system via the battery connection device; and
a detection circuit connected to the control circuit or the control system and configured to detect a parameter value of the battery connection device;
wherein the control circuit or the control system is further configured to determine health status of the battery connection device according to the parameter value of the battery connection device.

2. The detection system of claim 1, wherein:
the battery connection device includes a pair of connectors including:
a power supply side connector configured to be connected to the output end of the control circuit; and
a power receiving side connector configured to be connected to the control system;
the detection circuit is configured to detect a parameter value of the pair of connectors; and
the control circuit or the control system is further configured to determine health status of the pair of connectors according to the parameter value of the pair of connectors.

3. The detection system of claim 2, wherein:
the pair of connectors is one of a plurality of pairs of connectors of the battery connection device;
the detection circuit is further configured to detect a parameter value of at least one of the plurality of pairs of connectors; and
the control circuit or the control system is further configured to determine health status of the at least one of the plurality of pairs of connectors according to the parameter value of the at least one of the plurality of pairs of connectors.

4. The detection system of claim 3, wherein the plurality of pairs of connectors include:
a pair of a power supply side positive connector and a power receiving side positive connector; and
a pair of a power supply side negative connector and a power receiving side negative connector.

5. The detection system of claim 2, wherein:
the parameter value is one of a plurality of parameter values of the battery connection device detected by the detection circuit, the plurality of parameter values including a voltage at the power supply side connector, a voltage at the power receiving side connector, and a current flowing through the power supply side connector and the power receiving side connector; and
the control circuit or the control system is further configured to obtain a connector impedance of the power supply side connector and the power receiving side connector according to the plurality of parameter values, and determine the health status of the battery connection device according to the connector impedance.

6. The detection system of claim 5, wherein the control circuit or the control system is further configured to:
determine whether the connector impedance exceeds a threshold value; and
in response to determining that the connector impedance exceeds the threshold value:
determine that health status of the power supply side connector and the power receiving side connector is poor; and
issue a flight prohibition prompt message.

7. The detection system of claim 5, wherein the control circuit or the control system is further configured to:
obtain a connector temperature of the power supply side connector and the power receiving side connector according to the connector impedance;
determine whether the connector temperature exceeds a threshold value; and
in response to determining that the connector temperature exceeds the threshold value:
determine that health status of the power supply side connector and the power receiving side connector is poor; and
issue a flight prohibition prompt message.

8. The detection system of claim 5, wherein:
the plurality of parameter values include a plurality of sets of parameter values; and
the control circuit or the control system is further configured to:
obtain a plurality of impedance sampling values according to the plurality of sets of parameter values; and
filter the plurality of impedance sampling values to obtain the connector impedance.

9. The detection system of claim 5, wherein the control circuit or the control system is further configured to determine the health status of the battery connection device at a future moment according to values of the connector impedance at a plurality of past moments.

10. An unmanned aerial vehicle comprising:
a battery connection device;
a battery including:
a battery cell; and
a control circuit configured to control on-off of the battery cell, an input end of the control circuit being connected to the battery cell, and an output end of the control circuit being connected to the battery connection device;
a vehicle body including a control system connected to the battery connection device, the control system being configured to control the battery cell to supply power to the control system via the battery connection device; and
wherein:
the battery further includes a detection circuit connected to the control circuit or the vehicle body further includes the detection circuit connected to the control system;
the detection circuit is configured to detect a parameter value of the battery connection device; and
the control circuit or the control system is further configured to determine health status of the battery connection device according to the parameter value of the battery connection device.

11. The unmanned aerial vehicle of claim 10, wherein:
the battery connection device includes a pair of connectors including a power supply side connector and a power receiving side connector;
the battery includes the detection circuit, the detection circuit being connected to the power supply side connector via a wire to detect a voltage at the power supply side connector and a current flowing through the power supply side connector and the power receiving side connector;
the power supply side connector and the power receiving side connector include:
a power supply pin connected to the output end of the control circuit and the control system; and
a detection pin, one end of the detection pin being connected to the power receiving side connector, and another end of the detection pin being connected to the detection circuit;
the battery cell is configured to supply power to the control system via the power supply pin; and
the detection circuit is further configured to detect a voltage at the power receiving side connector via the detection pin.

12. The unmanned aerial vehicle of claim 10, wherein:
the battery connection device includes a pair of connectors including a power supply side connector and a power receiving side connector;
the vehicle body includes the detection circuit, the detection circuit being connected to the power receiving side connector via a wire to detect a voltage at the power receiving side connector;
the power supply side connector and the power receiving side connector include:
a power supply pin connected to the output end of the control circuit and the control system; and
a detection pin, one end of the detection pin being connected to the power supply side connector, and another end of the detection pin being connected to the detection circuit;
the battery cell is configured to supply power to the control system via the power supply pin; and
the detection circuit is further configured to detect a voltage at the power supply side connector and a current flowing through the power supply side connector and the power receiving side connector via the detection pin.

13. A detection method comprising:
detecting a parameter value of a battery connection device; and
determining health status of the battery connection device according to the parameter value of the battery connection device.

14. The detection method of claim 13, wherein the battery connection device includes a pair of connectors including a power supply side connector and a power receiving side connector.

15. The detection method of claim 14, wherein:
the pair of connectors is one of a plurality of pairs of connectors of the battery connection device;
detecting the parameter value of the battery connection device includes detecting a parameter value of at least one of the plurality of pairs of connectors; and
determining the health status of the battery connection device according to the parameter value of the battery connection device includes determining health status of the at least one of the plurality of pairs of connectors according to the parameter value of the at least one of the plurality of pairs of connectors.

16. The detection method of claim 15, wherein the plurality of pairs of connectors include:
a pair of a power supply side positive connector and a power receiving side positive connector; and
a pair of a power supply side negative connector and a power receiving side negative connector.

17. The detection method of claim 14, wherein:
the parameter value is one of a plurality of parameter values of the battery connection device detected by the detection circuit, the plurality of parameter values including a voltage at the power supply side connector, a voltage at the power receiving side connector, and a current flowing through the power supply side connector and the power receiving side connector; and
determining the health status of the battery connection device includes:
obtaining a connector impedance of the power supply side connector and the power receiving side connector according to the plurality of parameter values; and
determining the health status of the battery connection device according to the connector impedance.

18. The detection method of claim 17,
wherein determining the health status of the battery connection device according to the connector impedance includes:
determining whether the connector impedance exceeds a threshold value; and
in response to determining that the connector impedance exceeds the threshold value, determining that the health status of the power supply side connector and the power receiving side connector is poor;
the detection method further comprising:
issuing a flight prohibition prompt message in response to determining that the health status of the power supply side connector and the power receiving side connector is poor.

19. The detection method of claim 17,
wherein determining the health status of the battery connection device includes:
obtaining a connector temperature of the power supply side connector and the power receiving side connector according to the connector impedance;
determining whether the connector temperature exceeds a threshold value; and
in response to determining that the connector temperature exceeds the threshold value, determining that the health status of the power supply side connector and the power receiving side connector is poor;
the detection method further comprising:
issuing a flight prohibition prompt message in response to determining that the health status of the power supply side connector and the power receiving side connector is poor.

20. The detection method of claim 17, wherein:
the plurality of parameter values include a plurality of sets of parameter values; and
obtaining the connector impedance includes:
obtaining a plurality of impedance sampling values according to the plurality of sets of parameter values; and
filtering the plurality of impedance sampling values to obtain the connector impedance.
